(19) United States
(12) Patent Application Publication
(10) Pub. No.: US 2017/0323355 A1
(43) Pub. Date: Nov. 9, 2017

(54) METHOD AND SYSTEM FOR COLLECTING CUSTOMER FEEDBACK

(71) Applicant: MASTERCARD INTERNATIONAL INCORPORATED, Purchase, NY (US)

(72) Inventors: Randhir Kumar, Samastipur (IN); Amit Kumar Singh, Agra (IN); Rohit Modi, New Delhi (IN); Mayank Prakash, Dehradu (IN); Ashutosh Gupta, Varanasi (IN)

(21) Appl. No.: 15/587,609

(22) Filed: May 5, 2017

(30) Foreign Application Priority Data
May 5, 2016 (SG) 10201603575S

(51) Int. Cl. G06Q 30/02

(52) U.S. Cl. CPC G06Q 30/0282

(57) ABSTRACT

The present application provides methods and devices for collecting customer feedback. The methods comprise the steps of determining whether a received input string used to authenticate a payment instrument against which a transaction is charged contains customer feedback data, and extracting the customer feedback data in response to determining presence of the customer feedback data.

### FIELD OF INVENTION

The following discloses a method and system for collecting customer feedback.

### BACKGROUND

Companies and organization are increasingly being more concerned about customer experience. They have realized that customer experience plays a very crucial role in shaping their brand image and hence impacts attracted customer traffic. The feedback also helps them improve and modify their product/services accordingly.

Some existing channels used to capture customer feedbacks are as follows.

(1) Offline Survey Forms

These are mainly used by restaurants and shopping malls. Customers are asked to fill a form to rate various aspects of the availed product and services and their overall experience.

(2) Online Survey Forms

E-commerce portals present their customers with such forms, mostly in a form of a pop-up while browsing or through e-mails.

(3) Calls and SMS

Customers either get a call from the company representatives or an SMS asking for their feedback.

The above channels have been found to annoy customers. Such annoyance negatively impacts customer engagement. Further shortcomings are listed below.

Ecommerce websites send customers feedback surveys after a customer makes a purchase to understand the customer online browsing experience on their website. However, an online presence is required, and is thus not accessible to brick and mortar stores for tracking the customer experience in store. Moreover, the surveys sent from Ecommerce websites often go unanswered. Past data indicates that customers would only want to rate their experience only in case of dissatisfaction).

The above channel allows the merchant to only track the customer experience at its own store. It has no way of tracking the experience in the wider industry to benchmark.

There is thus a need for a technical solution to provide an non-intrusive way to get customer feedback. Furthermore, other desirable features and characteristics will become apparent from the subsequent detailed description and the appended claims, taken in conjunction with the accompanying drawings and this background of the disclosure.

### SUMMARY OF THE INVENTION

According to a first aspect of the present invention, there is provided a method for collecting customer feedback. The method comprises: determining whether a received input string used to authenticate a payment instrument against which a transaction is charged contains customer feedback data; and extracting the customer feedback data in response to determining presence of the customer feedback data.

According to a second aspect of the present invention, there is provided a computing device for collecting customer feedback. The computing device comprises at least one processor, at least one memory including computer program code, and at least one communication interface. The at least one memory and the computer program code are configured to, with at least one processor, cause the server at least to determine whether a received input string used to authenticate a payment instrument against which a transaction is charged contains customer feedback data; and extract the customer feedback data in response to determining presence of the customer feedback data.

### BRIEF DESCRIPTION OF THE DRAWINGS

Embodiments of the invention will be better understood and readily apparent to one of ordinary skilled in the art from the following written description, by way of example only, and in conjunction with the drawings, in which:

FIG. 1 shows a schematic of a POS terminal and an online payment terminal where each can accept an input string in which customer feedback may be embedded.

FIG. 2 shows a flowchart 200 depicting steps of a method for collecting customer feedback data in accordance with the embodiment 100.

FIG. 3 shows an exemplified table 300 listing exemplified extracted customer feedback data.

FIG. 4 shows an exemplified table 400 listing transaction data saved at a financial intermediary transaction server, wherein the extracted customer feedback data is comprised.

FIG. 5 shows an exemplary computing device 500 to realize a POS terminal or a server in accordance with the system shown in FIGS. 1 and 2.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The present application provides technical solutions for collecting customer feedback during payment of purchased goods and/or services at physical or online merchants. The payment can be made using a payment instrument. The payment instrument can be a credit card, a debit card or a pre-paid card such as a gift card issued by a financial institution. The financial institution can be a bank that issues the payment instrument (i.e. an issuer bank), or a financial intermediary (such as MasterCard, Visa, American Express, etc) that also provides a payment platform for various merchants.

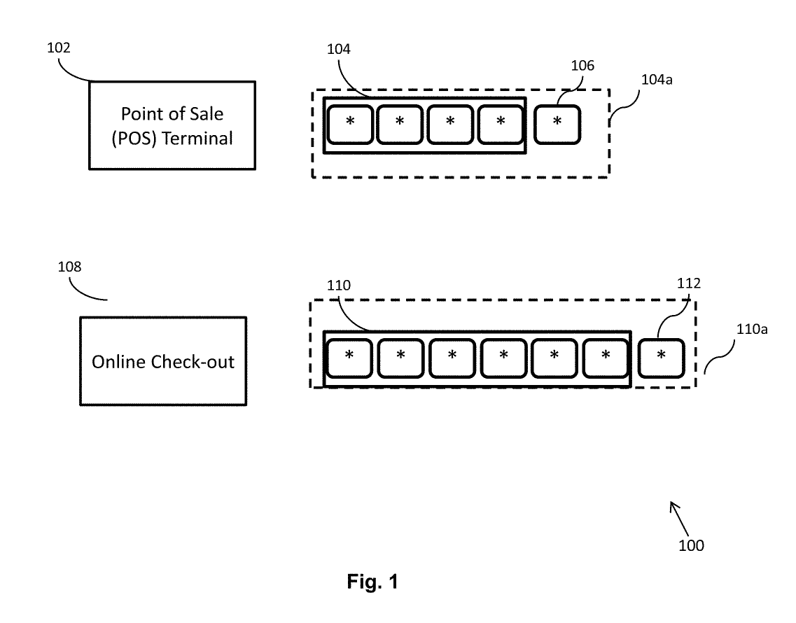

FIG. 1 shows a schematic of a POS terminal 102 and an online payment terminal 108 where each can accept an input string 104a, 110a in which customer feedback may be embedded. The POS terminal 102 is an electronic device used to process payment at a retail store. The online payment terminal 108 is an electronic system that performs payment process which allows payment for online purchases of goods and/or services at e-commerce businesses (such as online merchants, auction sites, etc). In the present disclosure, the terms “online payment terminal 108” and “online checkout 108” are used interchangeably. At both the POS terminal 102 and the online payment terminal 108, the input string 104a, 110a is used to authenticate a payment instrument (such as a credit card, a debit card or a pre-paid card) issued by a bank or a financial intermediary used to pay for goods and/or services purchased at the physical or online merchant. Such a credit card, debit card or pre-paid card has an embedded security chip in addition to a magnetic strip. As known, a personal identification number (PIN) or PIN code is a numeric password used to authenticate a credit card, debit card or pre-paid card. In accordance with an implementation of the present invention, it is recognised that since a cardholder of the payment instrument needs to enter his PIN to authenticate the payment instrument, the moment of requesting for the PIN to be entered provides an opportunity to obtain the cardholder's feedback of the purchase transaction.

As shown in FIG. 1, a Point of Sale (POS) terminal 102 is employed in a transaction where purchase of goods and/or services is made at a retail store In the transaction, the customer uses his/her security chip equipped credit card, debit card or pre-paid card as the payment instrument which is charged for the payment of the purchased goods and/or services.

In a typical PIN authorised transaction, the cardholder inserts the security chip equipped card, either a credit, debit or pre-paid card, into a slot in the POS terminal 102. Then, while the card stays in the slot, the cardholder enters a PIN code to verify that he/she is the legitimate cardholder and thereby authorise payment. The PIN code can be a static number having four (4) digit to twelve (12) digit length.

On the other hand, in FIG. 1, an additional character 106 can also be entered into the POS terminal 102, along with the authentication code 104 (i.e. the PIN) for the payment instrument, to form the input string 104a. It can be seen that the authentication code 104 in the present embodiment 100 is of four digit length. The additional character 106 is designated to indicate the customer's feedback of shopping at the retail store. The additional character 106 can be a number from 0 to 9 or a letter from A to Z entered into the POS terminal via a keypad of the POS terminal 102. The additional character 106 can be a measure of shopping satisfaction.

The additional character 106 can be entered as a first character of the input string 104a, followed by the authentication code 104. Alternatively, the additional character 106 can be a last character of the input string 104a, i.e. it is entered after the authentication code 104. The additional character 106 is an optional character. In scenarios where the customer chooses not to provide his/her feedback, he/she can omit entering this additional character 106.

Similarly, customer feedback can also be obtained for online purchase transactions with an online merchant.

In a typical online purchase transaction, the customer is required to enter a dynamic One Time Password (OTP) as an authentication code 110 at an online payment terminal/check-out 108 to authenticate the credit, debit or pre-paid card. The dynamic OTP can be required as an additional password to a pre-set static PIN code entered at the online payment terminal 108. The dynamic OTP can be generated by a device issued by the issuer bank or the financial intermediary, such as MasterCard, that issued the credit, debit or pre-paid card. The device can be a small keyring fob device with an OTP calculator built therein, a smartcard, or a specific cellphone. In an implementation, the device requires the static PIN code to generate the dynamic OTP 110 using the built-in OTP calculator.

Alternatively, in some embodiments of online payment, only the dynamic OTP is required as the authenticate code 110. The dynamic OTP can be generated by a server administered by the issuer bank or the financial intermediary and in communication with the online payment terminal 108. In such embodiments, the customer would need to enter card number with respective common procurement vocabulary (CPV) code of the credit, debit or pre-paid card at the online payment terminal 108. The card number with respective common procurement vocabulary (CPV) code received at the online payment terminal 108 will be sent to the server administered by the issuer bank or the financial intermediary to generate the dynamic OTP.

In other embodiments, if the online payment terminal 108 is administered by a financial institution such as MasterCard, a 6-digit static MasterCard SecureCode™ can be required as the authentication code 110.

For any of the online payment scenarios described above, an additional character 112 can also be entered at the online payment terminal 108 in an input string 110a along with the authentication code 110.

It can be seen that the authentication code 110 in the present embodiment 100 is of six digit length. The additional character 112 is designated to indicate the customer's feedback of shopping at the online merchant. The additional character 112 can be a number from 0 to 9 or a letter from A to Z entered into the online payment terminal 108. The additional character 112 can be a measure of shopping satisfaction.

Similarly as described above in the transaction at the physical merchant, the additional character 112 can be entered as a first character of the input string 110a, followed by the authentication code 110. Alternatively, the additional character 112 can be a last character of the input string 110a, i.e. it is entered after the authentication code 110. The additional character 112 is an optional character. In scenarios where the customer chooses not to provide his/her feedback, he/she can omit entering this additional character 112.

It will be appreciated by the skilled person that the verification process and payment settlement process which take place between a merchant server, an acquirer bank server and an issuer bank server, are not detailed in the present application for the sake of simplicity.

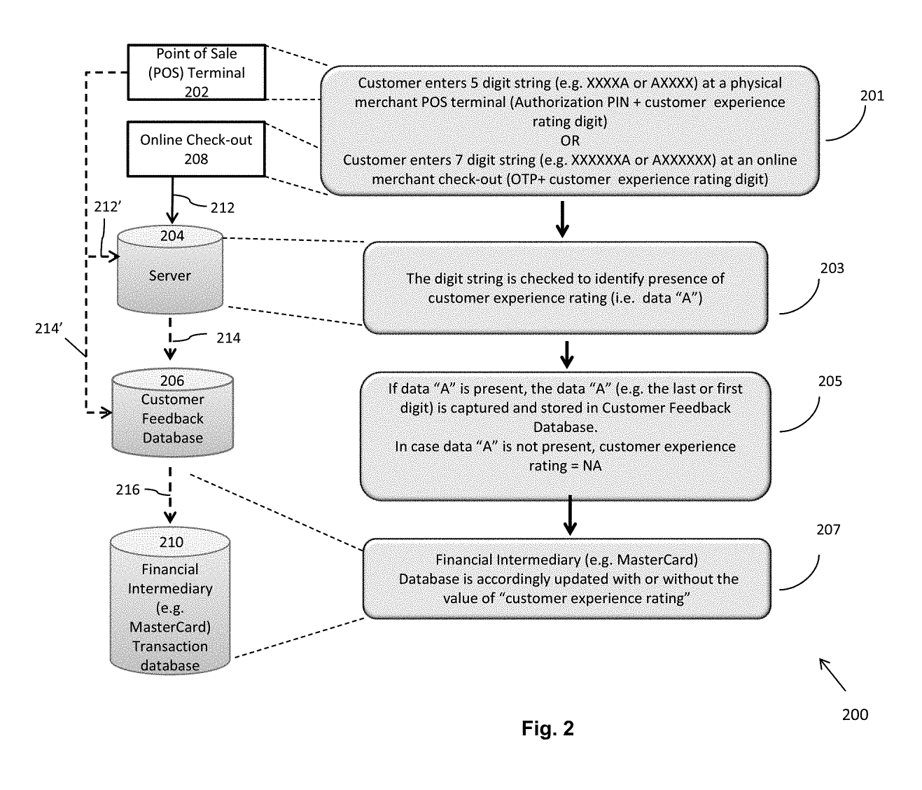

FIG. 2 shows an exemplary process 200 for collecting customer feedback. Reference is also made to relevant portions of the description above in respect of FIG. 1.

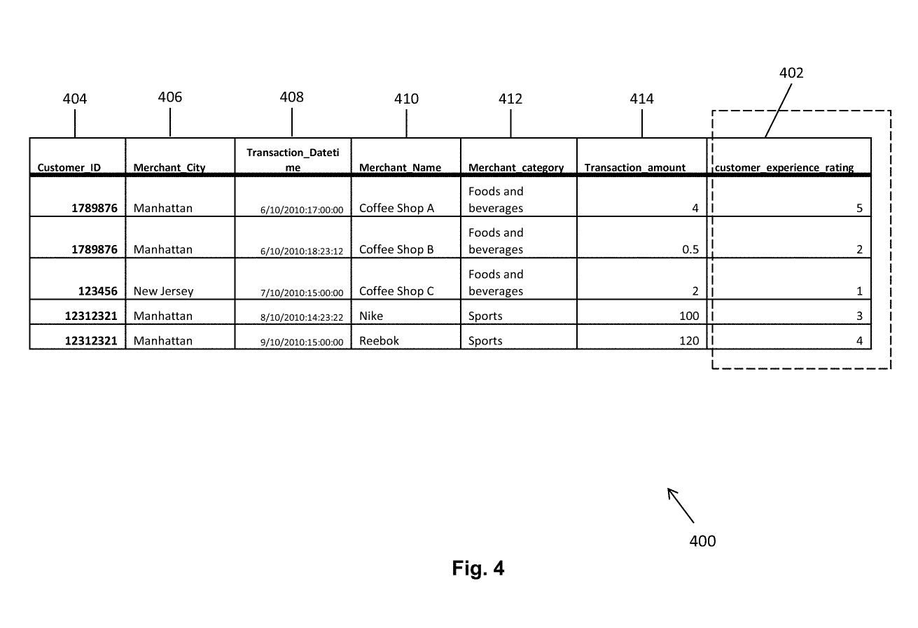

In step 203 of the exemplary process 200, the customer enters a 5-digit input string (e.g. XXXXA or AXXXX) at a POS terminal 202 of a retail store. The 5-digit input string is analogous to the input string 104a described in FIG. 1 which comprises the authorization code 104 (i.e. the PIN code) and the additional feedback character 106. The letter “A” is used in FIG. 2 to represent the additional feedback character that provides a customer experience rating. As shown in FIG. 4, the customer experience rating can vary from 1 to 5 to represent a degree of satisfaction of the shopping experience at the retail store.

Similarly, if the transaction in the present embodiment 200 is an online one, the customer enters a 7-digit input string (e.g. XXXXXXA or AXXXXXX) at online check-out 208. The 7-digit input string is analogous to the input string 110a described in FIG. 1 which comprises the authorization code 110 (i.e. the OTP code) and the additional feedback character 112. Again, the letter “A” is used to represent the additional feedback character that provides a customer experience rating data.

While FIG. 2 shows the customer experience rating data A placed as the first digit or the last digit of the input string 104a or 110a, it will be appreciated by the skilled person that the customer experience rating data A can be placed at any location within the input string 104a or 110a.

In step 203, the received input string 104a or 110a is checked to determine whether the input string 104a or 110a contains the customer experience rating data A. The step 203 can be performed locally on the POS terminal 202, given that the POS terminal 202 is configured to determine the presence of the customer feedback data in the received input string 104a or 110a.

On the other hand, the step 203 can be performed at a server 204. For example, in the online transaction scenario, the online check-out 208 forwards 212 the received input string 104a or 110a to the server 204 for the server 202 to determine the presence of the customer feedback data (i.e. the additional feedback character 106 or the customer experience rating data A). The server 204 can be either a merchant server 204, or an issuer bank server 204, or a financial intermediary server 204, or an acquirer bank server 204. In a further example, the POS terminal 202 after receiving the input string 104a or 110a can also forward 212′ the received input string 104a or 110a to the server 204 for the server 204 to determine the presence of the customer feedback data.

In step 205, if the POS terminal 202 or the server 204 determines that the customer feedback data (i.e. the additional feedback character 106 or the customer experience rating data A) is present, the customer feedback data is extracted from the received input string 104a or 110a.

In an implementation, the POS terminal 202 or the server 204 checks a length of the received input string 104a or 110a, then compares the length of the received input string 104a or 110a against a length of the authorization code 104 or 110 used to authenticate the payment instrument, i.e. the security chip equipped credit, debit or pre-paid card against which the purchases of goods and/or services are made.

As described in the foregoing, the length of the authorization code 104 or 110 is four (4) digits for transactions made at the physical merchant or six (6) digits for transactions made at the online merchant. It will be appreciated that the length of the authorization code 104 can vary according to various communication standards. Further, while the additional feedback character 106 is presented in the first digit or the last digit of the received input string 104a or 110a, it will be appreciated by the skilled person that there may be other designated segments within the received input string 104a or 110a reserved for storing customer feedback.

In the implementation where the customer provides feedback, i.e. the additional feedback character 106 is entered with the authorization code 104, the received input string 104a will be 5 characters long (for transactions made at the retail store) or the received input string 110a will be 7 characters long (for transactions made at the online merchant). The length of the received input string 104a, 110a will be longer than the length of the respective authorization code 104, 110 (input length of 5 characters versus authorization code length of 4 characters for the retail store scenario; and input length of 7 characters versus authorization code length of 6 characters for the online merchant scenario. This determines that the customer feedback is present. While the additional feedback character 106 in the present embodiments is of one (1) character length, it will be appreciated by the skilled person that the customer feedback data can be of different lengths according to different feedback types.

On the other hand, if the customer feedback data is omitted as the customer enters the authorization code 104 or 110, the length of the received input string 104a or 110a equals the length of the authorization code 104 or 110. In this scenario, it is determined that the customer feedback is not present.

In step 205, in response to the determination, by either the POS terminal 202 or the server 204, that the customer feedback is present in the received input string 104a or 110a, the customer feedback data will be extracted by the POS terminal 202 or the server 204.

In an implementation, the extracted customer feedback data can be forwarded from the POS terminal 202 or the server 204 and stored 214′ or 214 in a customer feedback database 206. The customer feedback database 206 can be administered by and is in communication with the server 204.

In another implementation 207, as the payment process proceeds, a financial intermediary (e.g. MasterCard) transaction database 210 which may be administered by and in communication with the intermediary server 204, can be updated in consequence of the determination 205 of the presence of the customer feedback data. If the customer feedback data is present, the financial intermediary transaction database 210 can be updated 216 with the extracted customer feedback data.

In a further implementation, the extracted customer feedback data can be tabulated in either the customer feedback database 206 or the financial intermediary transaction database 210 with other extracted customer feedback data. FIG. 4 shows how the customer feedback data is tabulated. Based on the tabulation of the customer data, the customer feedback database 206 or the financial intermediary transaction database 210 can generate at least one score/value to rate customer satisfaction. The tabulated customer feedback data will facilitate analysis of the collected customer feedback. Details of the tabulated customer feedback data and their possible applications are described with respect to FIG. 4.

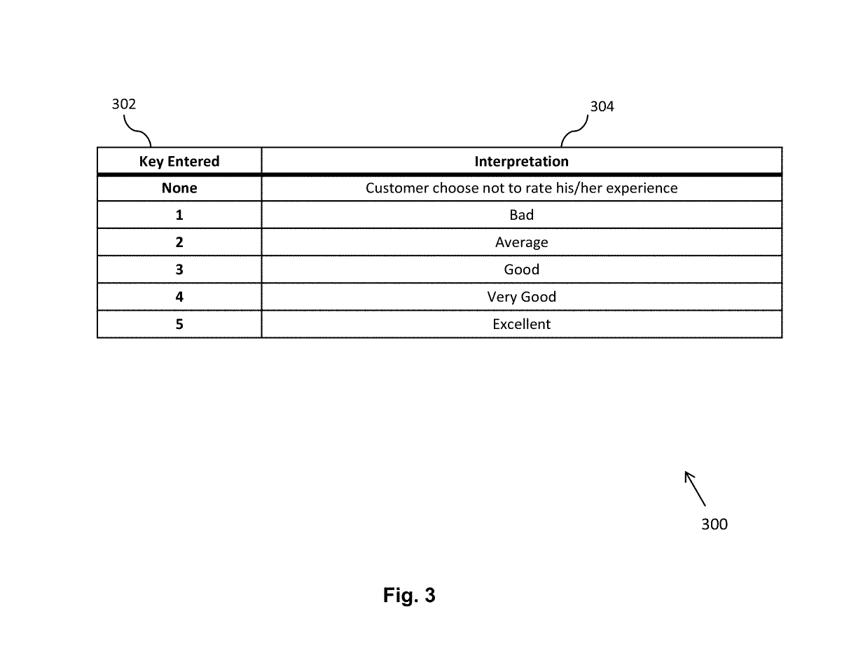

FIG. 3 illustrates a table 300 that shows what each number represents in the customer feedback data collected in accordance with FIGS. 1 and 2. In column 302, the present embodiment 300 shows five (5) examples of additional feedback character 106 or 112. Column 304 shows what each input value of the feedback character 106 or 112 means—value 1 represents that the customer's experience of the transaction is bad; value 2 represents average, value 3 represents good, value 4 represents very good, and value 5 represents excellent experience. While no value is entered for the customer feedback data, it simply represents that the customer chooses not to rate his/her experience.

FIG. 4 shows a table 400 of transaction data stored in the financial intermediary (e.g. MasterCard) transaction database 210 of FIG. 2. FIG. 4 is described with reference to FIGS. 1 and 2, where the extracted customer feedback data is saved 214/214′ in the customer feedback database 206 using the interpretation as set out in the table 300 of FIG. 3.

The table 400 comprises columns 402 for customer feedback data, 404 for Customer ID, 406 for merchant city, 408 for transaction date and time, 410 for merchant name, 412 for merchant category and 414 for transaction amount.

While customer feedback data is collected in accordance with FIGS. 1 and 2 and stored into column 402 of the table 400, it will be appreciated to the skilled person that the exemplary table 400 can help the merchants in knowing and analysing the feedback on the overall customer experience at different levels.

Firstly, the table 400 advantageously enables merchants to benchmark themselves against other merchants in the same industry. For example, Coffee shop A will want to know not only how customers rate them on an average in a certain month but also how customers rate the other merchants (like Coffee shops B, C etc.) that operate in the same category. For example, the table 400 stored in the financial intermediary, such as MasterCard, can inform Coffee Shop A that customers rate it 7 on an average while its top 5 competitors are rated 9 by customers. This can serve as an indicator to Coffee Shop A to work on improving the customer experience.

Secondly, the table 400 advantageously enables merchants to track customer experiences at their different stores/outlets and benchmark them against each other. This can help the merchants to know which of their stores are doing well and which are not doing well. In such a scenario, because products are almost similar across stores, conclusions drawn may be that the difference could be due to infrastructure/staff. An indicator is provided for the merchant to work on those aspects in certain stores which are scoring low in customer rating.

Thirdly, the table 400 advantageously enables the merchants to compare different modes of payment channel like E-commerce or POS. If there is a significant difference between them then there may be further scope to introspect. As such, if table 400 shows that E-commerce customer experience is not particularly good, it may be an indication that the online channels of the store is not that efficient and customer friendly.

Similarly, the table 400 can also be advantageously used for the acquirer bank, the issuer bank or the financial intermediary itself to have customer feedback on its financial products such as payment instruments or payment methods.

Further, it will be appreciated to the skilled person that the table 400 can facilitate financial institutions participating in the payment of purchases of goods and/or services in knowing and analysing the feedback on the overall customer experience at different levels.

Firstly, the table 400 advantageously enables the issuing bank to understand how certain products, such as credit, debit or pre-paid card services are doing and how they benchmark against their competitors.

Consider the scenario where a credit card or a pre-paid cash card is in the form of a rewards card. If a rewards card is not assigned with customer's value propositions, customers may generally rate their shopping experience lower when shopping with that rewards card. Based on the customer feedback data collected and presented in column 402, the table 400 may give a cue to the issuing bank to align the value proposition of cards with the customer's expectation.

Also, if the table 400 shows that a certain bank product provides high customer satisfaction particularly with certain merchants, it is advantageous for the issuer bank to launch a co-branded card for the bank with the particular merchants.

Secondly, the table 400 advantageously enables the acquirer banks to benchmark themselves against competitors and to understand if they are behind industry trends.

For example, in POS transactions customer experience may come down due to multiple failures of acquiring bank's network. This can be reflected in the customer feedback data collected and presented in column 402 of the exemplary table 400. This can be one of the factors based on which the acquirer banks may use to promote or market their payment network products. That is, if a certain acquirer bank is doing well compared to other acquirer banks in terms of customer experience, it may signify the particular acquirer bank's network reliability and the particular acquirer bank can use that advantage to sell its services.

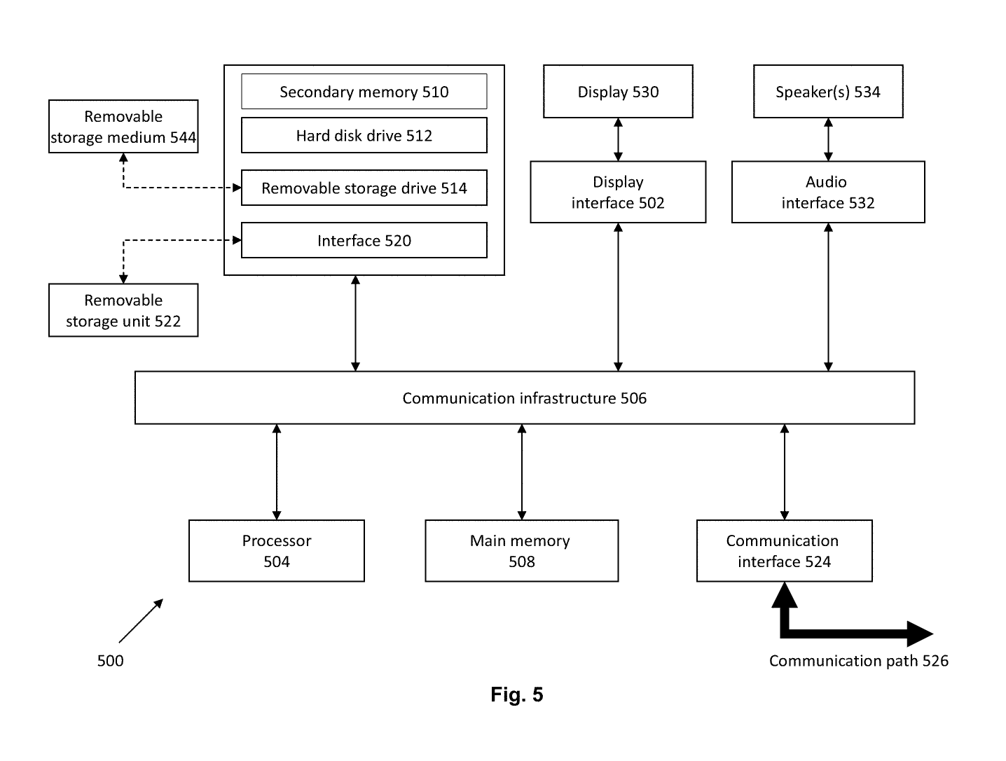

FIG. 5 depicts an exemplary computing device 500, hereinafter interchangeably referred to as a computer system 500, where one or more such computing devices 500 may be used to execute the above-described method for collecting customer feedback. The exemplary computing device 500 can be used to implement the POS terminal 202 or the server 204. The following description of the computing device 500 is provided by way of example only and is not intended to be limiting.

As shown in FIG. 5, the example computing device 500 includes a processor 504 for executing software routines. Although a single processor is shown for the sake of clarity, the computing device 400 may also include a multi-processor system. The processor 504 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 514, which may include a magnetic tape drive, an optical disk drive, a solid state storage drive (such as a USB flash drive, a flash memory device, a solid state drive or a memory card), or the like. The removable storage drive 514 reads from and/or writes to a removable storage medium 544 in a well-known manner. The removable storage medium 544 may include magnetic tape, optical disk, non-volatile memory storage medium, or the like, which is read by and written to by removable storage drive 514. As will be appreciated by persons skilled in the relevant art(s), the removable storage medium 544 includes a non-transitory or transitory computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 530. Examples of a removable storage unit 522 and interface 530 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 522 and interfaces 530 which allow software and data to be transferred from the removable storage unit 522 to the computer system 500.

The computing device 500 also includes at least one communication interface 524. The communication interface 524 allows software and data to be transferred between computing device 500 and external devices via a communication path 526. In various embodiments of the inventions, the communication interface 524 permits data to be transferred between the computing device 500 and a data communication network, such as a public data or private data communication network. The communication interface 524 may be used to exchange data between different computing devices 500 which such computing devices 500 form part an interconnected computer network. Examples of a communication interface 524 can include a modem, a network interface (such as an Ethernet card), a communication port (such as a serial, parallel, printer, GPIB, IEEE 1394, RJ45, USB), an antenna with associated circuitry and the like. The communication interface 524 may be wired or may be wireless. Software and data transferred via the communication interface 524 are in the form of signals which can be electronic, electromagnetic, optical or other signals capable of being received by communication interface 524. These signals are provided to the communication interface via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage medium 544, removable storage unit 522, a hard disk installed in storage drive 512, or a carrier wave carrying software over communication path 526 (wireless link or cable) to communication interface 524. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 504 to perform features of the above-described embodiments. Accordingly, such computer programs represent controllers of the computer system 500.

Software may be stored in a computer program product and loaded into the computing device 500 using the removable storage drive 514, the storage drive 512, or the interface 550. Alternatively, the computer program product may be downloaded to the computer system 500 over the communications path 526. The software, when executed by the processor 504, causes the computing device 500 to perform functions of embodiments described herein.

It is to be understood that the embodiment of FIG. 5 is presented merely by way of example to explain the operation and structure of the POS terminal 202 or the server 204. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

In one embodiment, the computing device 500 is implemented as the POS terminal 202 or the server 204 that is configured to determine whether the received input string 104a or 110a is used to authenticate the payment instrument, i.e. the security chip equipped credit, debit or pre-paid card, against which the transaction is charged contains the customer feedback data 106 or 112. The computing device 500 is further configured to extract the customer feedback data in response to determining presence of the customer feedback data.

In the present embodiment, the computing device 500 is further configured to determine a length of the received input string 104a or 110a, compare the length of the received input string 104a or 110a against a length of the authorization code 104 or 110 used to authenticate the security chip equipped credit, debit or pre-paid card, and determine that the customer feedback data is present when the received input string 104a or 110a is longer than the authorization code 104 or 110.

In an embodiment of determining the presence of the customer feedback data, the computing device 500 is further configured to detect whether a designated segment within the received input string 104a or 110a contains data. The data can be a number from 0 to 9 or a letter from A to Z, representing a measure of customer satisfaction. The data contained in the designated segment is reserved for customer feedback. In the embodiments illustrated in FIGS. 1 and 2, the designated segment can be the first character or the last character of the received input string 104a or 110a. Accordingly, in an implementation of extracting the customer feedback data, the computing device 500 is configured to extract information from a beginning or an end of the received input string.

It can be appreciated by the skilled person that the designated segments can be other character in the received input string 104a or 110a reserved for customer feedback.

As described earlier, the computing device 500 can be the POS terminal 202 or the server 204. In an embodiment where the computing device 500 is the server 204, the computing device 500 further comprises a customer feedback database 206, wherein the extracted customer feedback data is stored into the customer feedback database 206.

In a further embodiment where the computing device 500 is the server 204, the computing device 500 is further configured to tabulate the extracted customer feedback data with other extracted customer feedback data, and generate at least one score to rate customer satisfaction based on the result of the tabulation in accordance with the description corresponding to FIGS. 2, 3 and 4.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects illustrative and not restrictive.

1. A computer-implemented method for collecting customer feedback, the method comprising:
determining whether a received input string used to authenticate a payment instrument against which a transaction is charged contains customer feedback data; and
extracting the customer feedback data in response to determining presence of the customer feedback data.

2. The computer-implemented method of claim 1, wherein determination of the presence of the customer feedback data comprises:
determining a length of the received input string;
comparing the length of the received input string against a length of an authorization code used to authenticate the payment instrument; and
determining that the customer feedback data is present when the received input string is longer than the authorization code.

3. The computer-implemented method of claim 1, wherein determination of the presence of the customer feedback data comprises:
detecting whether a designated segment within the received input string contains data, the designated segment being reserved for customer feedback.

4. The computer-implemented method of claim 1, wherein extraction of the customer feedback data comprises:
extracting information from a beginning or an end of the received input string.

5. The computer-implemented method of claim 1, wherein the customer feedback data has a length of at least one character.

6. The computer-implemented method of claim 1, wherein the method is performed at a server configured to collect customer feedback and wherein the method further comprises storing the extracted customer feedback data into a customer feedback database of the server.

7. The computer-implemented method of claim 1, wherein the method is performed at a POS terminal and wherein the method further comprises transmitting the extracted customer feedback data to a server configured to collect customer feedback for storage into a customer feedback database of the server.

8. The computer-implemented method of claim 1, further comprising:
tabulating the extracted customer feedback data with other extracted customer feedback data; and
generating at least one score to rate customer satisfaction based on the result of the tabulation.

9. The computer-implemented method of claim 1, wherein the received input string comprises a PIN number.

10. A computing device for collecting customer feedback, the computing device comprising:
at least one processor;
at least one memory including computer program code; and
at least one communication interface;
the at least one memory and the computer program code configured to, with at least one processor, cause the server at least to:
determine whether a received input string used to authenticate a payment instrument against which a transaction is charged contains customer feedback data; and
extract the customer feedback data in response to determining presence of the customer feedback data.

11. The computing device of claim 10, wherein the computing device is further configured to, when determining the presence of the customer feedback data:
determine a length of the received input string;
compare the length of the received input string against a length of an authorization code used to authenticate the payment instrument; and
determine that the customer feedback data is present when the received input string is longer than the authorization code.

12. The computing device of claim 10, wherein the computing device is further configured to, when determining the presence of the customer feedback data:
detect whether a designated segment within the received input string contains data, the designated segment being reserved for customer feedback.

13. The computing device of claim 10, wherein the computing device is further configured to, when extracting the feedback data:
extract information from a beginning or an end of the received input string.

14. The computing device of claim 10, wherein the computing device is a server configured to collect customer feedback or a POS terminal.

15. The computing device of claim 14, wherein the server further comprises a customer feedback database, wherein the extracted customer feedback data is stored into the customer feedback database.

16. The computing device of claim 14, wherein the server is further configured to:
tabulate the extracted customer feedback data with other extracted customer feedback data; and
generate at least one score to rate customer satisfaction based on the result of the tabulation.

17. A non-transitory computer readable medium having stored thereon executable instructions for controlling a computer to collect customer feedback at the time of making payment for a transaction, wherein the computer is controlled to perform steps comprising:
determining whether a received input string used to authenticate a payment instrument against which a transaction is charged contains customer feedback data; and
extracting the customer feedback data in response to determining presence of the customer feedback data.
